(19) United States
(12) Patent Application Publication
(10) Pub. No.: US 2026/0135704 A1
(43) Pub. Date: May 14, 2026

(54) SECURE STORAGE AND INTEGRITY CHECK OF SECRETS

(71) Applicant: CyberArk Software Ltd., Petach-Tikva (IL)

(72) Inventors: Anand MOKASHI, Maharashtra (IN); Subrat Kumar KHETI, Odisha (IN)

(73) Assignee: CyberArk Software Ltd., Petach-Tikva (IL)

(21) Appl. No.: 19/002,936

(22) Filed: Dec. 27, 2024

(30) Foreign Application Priority Data
Nov. 13, 2024 (IN) 202411087578

(51) Int. Cl. H04L 9/08; H04L 9/06; H04L 9/16

(52) U.S. Cl. CPC H04L 9/0894; H04L 9/0643; H04L 9/0861; H04L 9/0891; H04L 9/16

(57) ABSTRACT

Disclosed embodiments relate to systems and methods for securely storing a secret. Techniques include accessing a secret associated with a network identity and generating a primary encryption key for encrypting the secret. Generating the primary encryption key includes: accessing a first encryption key associated with the network identity, accessing a second encryption key stored in a process memory location associated with a machine of the network identity, and applying a primary key hash function to the first encryption key and the second encryption key to generate the primary encryption key. Techniques further include encrypting the secret using the primary encryption key to generate an encrypted secret; obfuscating the encrypted secret to generate an obfuscated encrypted secret; and storing the obfuscated encrypted secret in a secured storage location associated with the machine of network identity.

### CROSS REFERENCES TO RELATED APPLICATIONS

This application claims the benefit of priority of Indian Provisional Patent Application No. 202411087578, filed Nov. 13, 2024. The foregoing application is incorporated herein by reference in its entirety.

### BACKGROUND

### Technical Field

The present disclosure relates generally to cybersecurity and, more specifically, to techniques for securely storing, retrieving, and performing integrity checks on secrets.

### Background Information

As cybersecurity is an ever-growing concern, it is increasingly important for organizations and individuals alike to minimize potential attack surfaces within a network environment. Cybersecurity attacks may involve attackers compromising accounts of network users and accessing their credentials and network permissions. This may provide these attackers with access to the network's sensitive information and, in turn, enable the attackers to exfiltrate such information or compromise sensitive systems within the network.

One potential vulnerability may arise when a password or other secret is stored locally on a client device. For example, many organizations use security management software that may at least temporarily store and retrieve a password to assert on behalf of a user, which may create a potential attack surface. It may thus be advantageous to store the password as securely as possible. Some existing techniques use encryption for storing a secret. However, these encryption schemes typically require an encryption key to enable encryption and decryption of the secret, which itself must be stored. If this encryption key is obtained, it may be equally if not more dangerous for security of a network.

Accordingly, in view of these and other deficiencies in existing techniques, technological solutions are needed for securely storing secrets within a client device. Advantageously, any encryption key should be stored in a distributed fashion such that it is difficult to identify and extract by an attacker. Moreover, the solutions should enable integrity checks of the stored secret by security applications and/or administrators.

### SUMMARY

The disclosed embodiments describe non-transitory computer readable media, systems, and methods for securely storing secrets and enabling integrity checks of the secrets. For example, in an embodiment, a non-transitory computer readable medium may include instructions that, when executed by at least one processor, cause the at least one processor to perform operations for securely storing a secret. The operations may comprise accessing a secret associated with at least one network identity and generating a primary encryption key for encrypting the secret. Generating the primary encryption key may include: accessing a first encryption key associated with the at least one network identity, accessing a second encryption key stored in a process memory location associated with a machine of the at least one network identity, and applying a primary key hash function to the first encryption key and the second encryption key to generate the primary encryption key. The operations may further comprise encrypting the secret using the primary encryption key to generate an encrypted secret; obfuscating the encrypted secret to generate an obfuscated encrypted secret; and storing the obfuscated encrypted secret in a secured storage location associated with the machine of the at least one network identity.

According to a disclosed embodiment, the first encryption key associated with the at least one network identity may be unique to the secret.

According to a disclosed embodiment, the first encryption key may be stored encrypted in a registry associated with the machine of the at least one network identity.

According to a disclosed embodiment, the second encryption key may be stored such that it is unaffected by a process dump associated with the machine of the at least one network identity.

According to a disclosed embodiment, the second encryption key may be hard-coded into a coding of a software agent and wherein the second encryption key is loaded into the process memory with the coding of the software agent.

According to a disclosed embodiment, the second encryption key may be stored in a predetermined format.

According to a disclosed embodiment, the predetermined format may include a hexadecimal array.

According to a disclosed embodiment, the secret may include at least one of a password, an access-token, a PIN, a username, or biometric data.

According to a disclosed embodiment, the primary key hash function may be configured to generate the primary encryption key to have a predetermined bit length.

According to a disclosed embodiment, encrypting the secret using the primary encryption key may further include applying a salt to the secret.

According to a disclosed embodiment, the salt may be associated with the machine of the at least one network identity.

According to a disclosed embodiment, the salt may include an identifier of the computing device.

According to a disclosed embodiment, access to the secured storage location may be restricted to the at least one network identity.

According to a disclosed embodiment, storing the obfuscated encrypted secret may include generating an obscured filename for the encrypted secret, the obscured filename being associated with the at least one network identity.

According to another disclosed embodiment, there may be a computer-implemented method for securely storing a secret. The method may comprise accessing a secret associated with at least one network identity and generating a primary encryption key for encrypting the secret. Generating the primary encryption key may include: accessing a first encryption key associated with the at least one network identity, accessing a second encryption key stored in a process memory location associated with a machine of the at least one network identity, and applying a primary key hash function to the first encryption key and the second encryption key to generate the primary encryption key. The method may further comprise encrypting the secret using the primary encryption key to generate an encrypted secret; obfuscating the encrypted secret to generate an obfuscated encrypted secret; and storing the obfuscated encrypted secret in a secured storage location associated with the machine of the at least one network identity.

According to a disclosed embodiment, the method may further comprise generating a reference hash of the secret.

According to a disclosed embodiment, the method may further comprise storing the reference hash of the secret in a registry in an encrypted format.

According to a disclosed embodiment, the method may further comprise receiving a request to access at least one secured resource by the at least one network identity and authenticating the at least one network identity based on the reference hash of the secret.

According to a disclosed embodiment, authenticating the at least one identity based on the reference hash of the encrypted secret may include: accessing the obfuscated encrypted secret from the secured storage location; de-obfuscating the obfuscated encrypted secret; generating a computed hash of the de-obfuscated secret; and comparing the computed hash of the de-obfuscated secret to the reference hash of the secret.

According to a disclosed embodiment, the method may further comprise determining, based on the comparison, that the at least one network identity is not authenticated; and performing, based on the determination that the at least one network identity is not authenticated, at least one control action.

According to a disclosed embodiment, the at least one control action may include resetting the secret.

According to a disclosed embodiment, the method may further comprise determining, based on the comparison, that the at least one network identity is authenticated; and allowing access to the at least one secured resource by the at least one network identity using the secret.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example system environment for secure storage and management of secrets, consistent with the disclosed embodiments.

FIG. 2 is a block diagram showing an example computing device, consistent with the disclosed embodiments.

FIG. 3 is a block diagram showing an example operating system, consistent with the disclosed embodiments.

FIG. 4 is a block diagram illustrating an example process for secure storage of a secret 410, consistent with the disclosed embodiments.

FIG. 5 is a block diagram illustrating an example process for performing an integrity check of a stored secret, consistent with the disclosed embodiments.

FIG. 6 is a flowchart showing an example process for securely storing a secret, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for securely storing secrets described herein overcome several technological problems relating to security, efficiency, and flexibility in the fields of cybersecurity and network security. For example, the disclosed embodiments provide particular techniques for storing a secret, such as a password, locally on a client computing device in a manner that minimizes a potential attack surface associated with the stored secret. The disclosed techniques may include an encryption algorithm in which the secret is encrypted using a primary encryption key. To prevent the key from being obtained by malicious actors, the key may be generated on a just-in-time basis based on multiple factors. For example, the primary key may be generated based on multiple keys which may be stored in a distributed fashion. Further, each of the keys may be stored in a secure manner to prevent the keys from being identified by potential attackers. And the primary key may be generated based on the stored keys using a specific hashing algorithm. Together, these factors make obtaining the primary key difficult if not impossible for potential attackers. As an additional layer of security, when encrypting the secret using the primary key, a salt specific to a local machine may be applied to ensure that the key may be generated only on the local machine. And finally, the encrypted secret may be obfuscated prior to being stored in a secure location.

Using these techniques, a secret may be safely stored on a local machine for a user. These techniques may have a wide variety of potential applications. For example, some operating systems may require a password for a user to be entered each time the device restarts, which may interfere with some network or cloud-based authentication schemes. A passwordless authentication technique, for example, which may not require a user to enter a password during each login, provides an added security benefit of minimizing exposure of a password to potential attackers. However, if a password must be asserted each time a device restarts, the password would need to be stored and retrieved to be asserted for the user as a background process. Using the techniques disclosed herein, the password may be stored locally in a secure manner, thus enabling the passwordless authentication scheme to be implemented.

Reference will now be made in detail to the disclosed embodiments, examples of which are illustrated in the accompanying drawings.

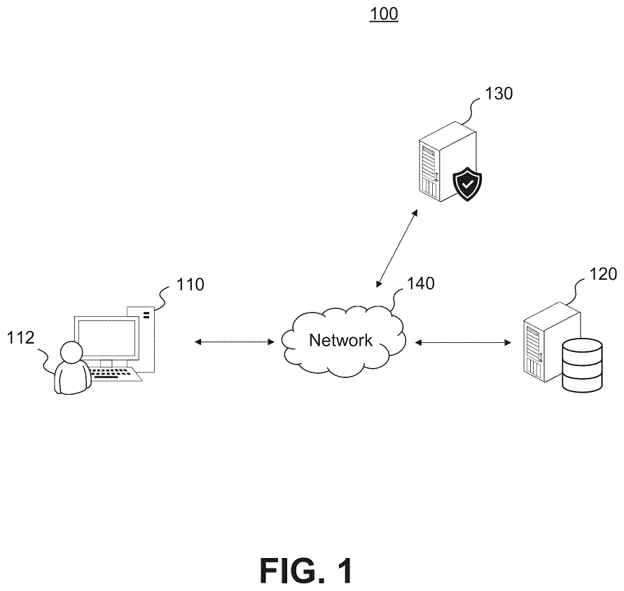

FIG. 1 illustrates an example system environment 100 for secure storage and management of secrets, consistent with the disclosed embodiments. System environment 100 may include one or more computing devices 110, one or more target resources 120, and one or more security servers 130, as shown in FIG. 1. System environment 100 may represent a system or network environment in which various computing operations may be performed. For example, computing device 110 (or an entity associated with computing device 110, such as identity 112) may request to perform a computing operation within system environment 100. In some embodiments, this may include a network-based computing operation. For example, this may include an operation involving a file or other data on target resource 120. Alternatively or additionally, this may include a local computing operation. For example, the local computing operation may be an operation involving a file stored in computing device 110. Accordingly, while system environment 100 is shown in FIG. 1 to include target resource 120 and security server 130 separately from computing device 110 by way of example, in some embodiments, one or both of target resource 120 and security server 130 may be integrated with computing device 110. For example, target resource 120 may be a local resource of computing device 110 and security server 130 may be an agent or other process running on computing device 110. Accordingly, system 100 may not necessarily be a network-based system environment and may be a local environment of computing device 110.

The various components of system environment 100 may be configured to communicate over a network 140. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 100 is shown as a network-based environment, it is understood that in some embodiments, one or more aspects of the disclosed systems and methods may also be used in a localized system, with one or more of the components communicating directly with each other.

As noted above, system environment 100 may include one or more computing devices 110. Computing device 110 may include any device that may be used for performing various computing operations as described herein. Accordingly, computing device 110 may include various forms of computer-based devices, such as a workstation or personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may be capable of performing a computing operation. In some embodiments, computing device 110 may be a virtual machine (e.g., based on AWS™, Azure™, IBM Cloud™, etc.), container instance (e.g., Docker™ container, Java™ container, Windows Server™ container, etc.), or other virtualized instance.

In some embodiments, computing device 110 may be associated with an identity 112. Identity 112 may be any entity that may be associated with one or more privileges required to perform a computing operation. For example, identity 112 may be a user, an account, an application, a process, a service, an electronic signature, or any other entity or attribute associated with one or more components of system environment 100. In some embodiments, identity 112 may be a user requesting to perform a computing operation through computing device 110. As noted above, this may be a computing operation associated with data on computing device 110, target resource 120, and/or security server 130.

Target resource 120 may include any form of remote computing device that may be the target of a computing operation or computing operation request. Examples of network resource 120 may include SQL servers, databases or data structures holding confidential information, restricted-use applications, operating system directory services, access-restricted cloud-computing resources (e.g., an AWS™ or Azure™ server), sensitive IoT equipment (e.g., physical access control devices, video surveillance equipment, etc.), and/or any other computer-based equipment or software that may be accessible over a network. Target resource 120 may include various other forms of computing devices, such as a mobile device (e.g., a mobile phone or tablet), a wearable device (a smart watch, smart jewelry, implantable device, fitness tracker, smart clothing, or head-mounted display, etc.), an IoT device (e.g., a network-connected appliance, vehicle, lighting, thermostat, room access controller, building entry controller, parking garage controller, sensor device, etc.), a gateway, switch, router, portable device, virtual machine, or any other device that may be subject to computing operations. In some embodiments, target resource 120 may be a privileged resource, such that access to the target resource 120 may be limited or restricted. For example, access to the target resource 120 may require a secret (e.g., a password, a username, an SSH key, an asymmetric key, a security or access token, etc.). In some embodiments target resource 120 may not necessarily be a separate device from computing device 110 and may be a local resource. Accordingly, target resource 120 may be a local hard drive, database, data structure, or other resource integrated with computing device 110.

Security server 130 may be configured to monitor and/or manage one or more security policies within system environment 100. For example, security server 130 may manage one or more privileges associated with identity 112 (or computing device 110) required to perform computing operations within system environment 100. In some embodiments, security server 130 may represent a privileged access management (PAM) system or other access management system implemented within system environment 100. Alternatively or additionally, security server 130 may be a security information and event management (SIEM) resource implemented within system environment 100. Security server 130 may be configured to grant, track, monitor, store, revoke, validate, or otherwise manage privileges of various identities within system environment 100. While illustrated as a separate component of system environment 100, it is to be understood that security server 130 may be integrated with one or more other components of system environment 100. For example, in some embodiments, security server 130 may be implemented as part of target network resource 120, computing device 110, or another device of system environment 100. In some embodiments, a separate security server may not be used and a security policy may be enforced through a security agent running on a computing device, such as security agent 340 as described below. Alternatively or additionally, the security agent may communicate with security server 130 to enforce security policies.

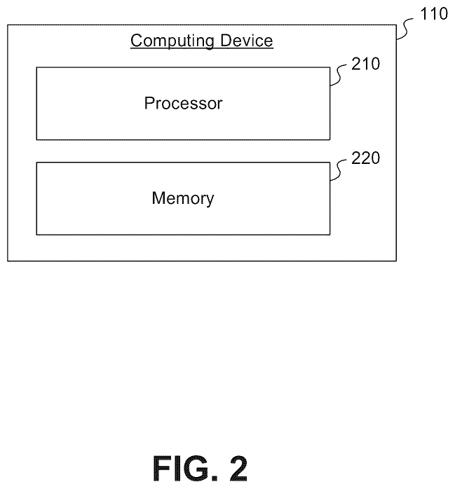

FIG. 2 is a block diagram showing an example computing device 110, consistent with the disclosed embodiments. As described above, computing device 110 may be a device configured to perform (or request to perform) one or more computing operations and may include one or more dedicated processors and/or memories. For example, computing device 110 may include a processor (or multiple processors) 210, and a memory (or multiple memories) 220, as shown in FIG. 2.

Processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. Processor 210 may also be a processor based on the ARM architecture, a processor based on the RISC-V architecture, a mobile processor, a graphics processing unit, or any other form of processor. The disclosed embodiments are not limited to any particular type of processor configured in computing device 110.

Memory 220 may include one or more storage devices configured to store instructions used by the processor 210 to perform functions related to computing device 110 described herein. The disclosed embodiments are not limited to particular software programs or devices configured to perform dedicated tasks. For example, the memory 220 may store a single program, such as a user-level application, that performs the functions associated with the disclosed embodiments, or may comprise multiple software programs. Additionally, the processor 210 may, in some embodiments, execute one or more programs (or portions thereof) remotely located from computing device 110. Furthermore, memory 220 may include one or more storage devices configured to store data for use by the programs. Memory 220 may include, but is not limited to a hard drive, a solid state drive, a CD-ROM drive, a transient or temporary storage device (e.g., a random-access memory (“RAM”)), a peripheral storage device (e.g., an external hard drive, a USB drive, etc.), a network drive, a cloud storage device, or any other storage device.

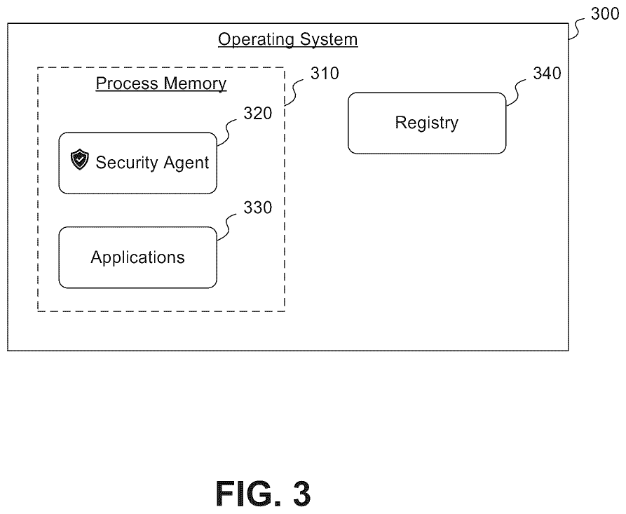

Computing device 110 may include various secure storage locations that may be used to facilitate the secure storage of secrets as disclosed herein. These storage locations may take various forms, such as the system registry of computing device 110, a process memory of computing device 110, or the like. FIG. 3 is a block diagram showing an example operating system 300, consistent with the disclosed embodiments. Operating system 300 may represent an operating system of a computing device through which a computing operation is performed (or requested to be performed). For example, operating system 300 may be an operating system of computing device 110 and thus may be executing using processor 210 and/or memory 220, as described above.

In some embodiments, operating system 300 may be a Microsoft Windows™ operating system. However, one of ordinary skill in the art would recognize that various aspects of the disclosed embodiments may equally apply in other types of operating platforms, such as Linux™, Apple macOS™, Apple iOS™, Google Android™, or the like. Operating system 300 may include a process memory 310, as shown in FIG. 3. Process memory 310 may represent a portion of memory 310 used by a process in an operating system to store code, data, and other information. For example, computing device 110 may be used to run various applications 330, which may consume memory from process memory 310 for performing various tasks. Process memory 310 may thus include executable code for applications 330. In some embodiments, computing device 110 may be used to run a security agent application, such as security agent 320. Security agent 320 may be associated with security server 130 and may be configured to perform various security functions for computing device 110 and/or user 112. For example, security agent 320 may be configured to enforce authentication. Once computing device 110 is configured using security agent 320, users (such as identity 112) can authenticate to computing device 110 without connecting to security server 130. In some embodiments, security agent 320 may facilitate passwordless authentication, in which a password (i.e., a secret) may be stored in an encrypted format and automatically retrieved in the background. As one example, security agent 320 may correspond to the CyberArk™ Windows Cloud Agent, which may manage authentication of users. The disclosed techniques may provide for improved security for storing passwords or other secrets. While passwordless authentication is provided by way of example, one of ordinary skill in the art would recognize that the techniques disclosed herein may be implemented for storing a wide range of secret or secure data.

As shown in FIG. 3, operating system 310 may further include a registry 340 which may be a repository of configuration data for computing device 110, including settings for hardware, applications, and users. For example, in embodiments where operating system 310 is a Microsoft Windows™ operating system, registry 340 may be a Windows™ Registry. Operating system 310 may be configured such that applications 330 and security agent 320 may store information for managing configuration settings or other information for the application. For example, when security agent 320 or other applications are installed, a new subkey may be generated in registry 340, which may include settings such as the program's location, version, and initiation data. Consistent with the disclosed embodiments, security agent 320 may be configured to store various data, such as encryption keys to facilitate the secure storage of secrets, as described further below.

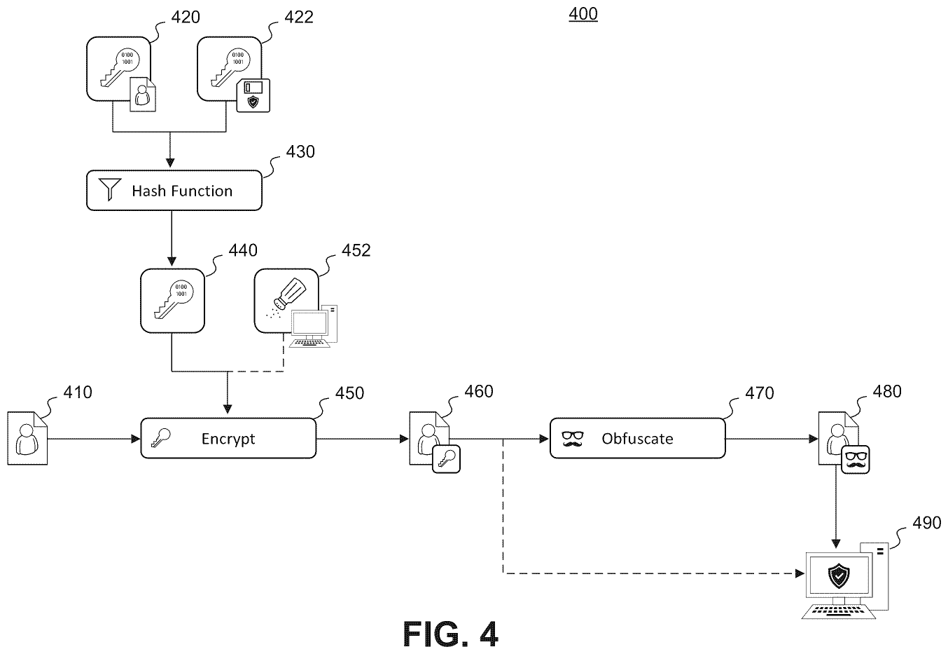

FIG. 4 is a block diagram illustrating an example process 400 for secure storage of a secret 410, consistent with the disclosed embodiments. As used herein, a secret may refer to any form of sensitive information that may be desirable to store in a secure manner. In some embodiments, secret 410 may be a credential, such as a password of identity 112. For example, identity 112 may be required to enter a password to login to computing device 110 or operating system 310, to access an application (i.e., application 330 or security agent 320), to access a target resource (e.g., target resource 120), or various other actions that may require a credential. In some embodiments, secret 410 may be a credential generated or provided by a user, such as identity 112. Alternatively or additionally, secret 410 may be generated automatically and provisioned to identity 112. In some embodiments, identity 112 may not know or have access to secret 410. For example, secret 410 may be a secret that is automatically generated as a background process and may be used for “passwordless” authentication of identity 112. Consistent with the disclosed embodiments, secret 410 may include various other information, such as a username, an SSH key, an asymmetric key, a symmetric key, a security or access token, a hash value, biometric data, personal data, confidential information, or the like.

To prevent unwanted or unauthorized access to secret 410, process 400 may provide a particular process for encrypting, obfuscating, and storing secret 410 in a secured storage location 490. Process 400 may include a particular combination of encryption keys, hash functions, encryption functions, and secure storage locations to provide improved security for storing secret 410. For example, as shown in FIG. 4, secret 410 may be encrypted through an encryption function 450 using a primary encryption key 440. Under conventional storage techniques, an encryption key such as primary encryption key 440 may be stored somewhere within computing device 110 or network 140. However, this presents a potential vulnerability where if primary encryption key 440 were acquired by a malicious actor, secret 410 may be also compromised.

Accordingly, using the disclosed techniques, primary encryption key 440 may not be directly stored but may be generated using multiple factors. For example, process 400 may include accessing a first encryption key 420 and a second encryption key 422, which may be used to generate primary encryption key 440. In some embodiments, first encryption key 420 may be a “per-secret” key associated with secret 410 and may be a dedicated or unique key for secret 410. For example, first encryption key 420 may be generated along with secret 410 and assigned exclusively to secret 410. In some embodiments, first encryption key 420 may be part of a user profile for identity 112. For example, first encryption key 420 may be stored in registry 340. According to some embodiments, first encryption key 420 may be stored in a portion of registry 340 specific to identity 410, for example under a HKEY_CURRENT_USER container. First encryption key 420 may be stored in a variety of formats. In some embodiments, first encryption key 420 may be stored as a 32-byte key in registry 340. To provide further protection, first encryption key 420 may itself be encrypted using a separate key. For example, first encryption key 420 may be encrypted using key generation and storage tool of operating system 310, such as Windows CryptoAPI or similar encryption tools. The encrypted first encryption key 420 may be stored in registry 340 in a binary format.

Second encryption key 422 may be an additional, separate encryption key used to generate primary encryption key 440. Second encryption key 422 may be stored in a separate location from first encryption key 420, thus making it significantly more difficult to obtain primary encryption key 440. In some embodiments, second encryption key 422 may be a “shared” key, and thus may not necessarily be unique to secret 410. Accordingly, second encryption key 422 may be used to encrypt secrets other than secret 410, which may be secrets associated with other users and/or for other computing devices. In some embodiments, second encryption key 422 may be stored in a strategic manner to avoid second encryption key 422 from being obtained by a malicious attacker. For example, second encryption key 422 may be stored in a manner such that it is not vulnerable to process memory dumps or binary extraction. In a process memory dump attack, an attacker may exfiltrate the memory of a running process and find plaintext encryption keys or credentials. To avoid such attacks, second encryption key 422 may be hard coded into a software application, such as secure agent 320. Accordingly, second encryption key 422 may be loaded into process memory 310 when security agent 320 is initiated. Moreover, second encryption key 422 may be hard-coded as a 32-byte hexadecimal array, thus making it nearly impossible to identify within the code.

First encryption key 420 and second encryption key 422 may be combined in various ways to generate primary encryption key 440. Accordingly, primary encryption key 440 may be a distributed key, which may greatly reduce the likelihood that it will be obtained maliciously. As an additional factor to improve security, primary encryption key 440 may be generated based on first encryption key 420 and second encryption key 422 using a cryptographic hash function 430. As one example, cryptographic hash function 430 may be a secure hash algorithm, such as a SHA-256 algorithm or other SHA-2 algorithm used to generate primary encryption key 440. For example, primary encryption key 440 may be derived using a key derivation function, such as a HMAC-based Extract-and-Expand Key Derivation Function (HKDF), which may use first encryption key 420 and second encryption key 422 as input key material. Accordingly, rather than storing primary encryption key 440 itself, primary encryption key 440 may be generated using multiple components, such as first encryption key 420, second encryption key 422, and cryptographic hash function 430, thus ensuring primary encryption key 440 is difficult if not impossible to generate by a malicious user.

As shown in FIG. 4, secret 410 may then be encrypted using encryption function 450 to generate an encrypted secret 460. Encryption function 450 may include any suitable form of encryption algorithm that may use a primary encryption key 440. Continuing with the example described above, where primary encryption key 440 may include an AES256 encryption key generated using HKDF, encryption function 450 may be an AES256 encryption algorithm. Accordingly, encrypted secret 460 may be a cipher generated based on secret 410 as plain text or data. While AES256 is provided by way of example, various other encryption standards may equally be used. In some embodiments, secret 410 may further be encrypted using a cryptographic salt 442. For example, may be appended to secret 410 prior to being encrypted using encryption function 450. According to some embodiments, cryptographic salt 442 may be a random string of data to further enhance encryption function 450. Alternatively or additionally, cryptographic salt 442 may be a specific string. For example, cryptographic salt 442 may be a value specific to computing device 110, such as a machine identifier, model number, version number, or various other forms of data associated with computing device 110. Adding cryptographic salt 442 in this manner may ensure that any potential attack would have to be carried out on the same machine that primary encryption key 440 is obfuscated and stored, thus drastically limiting the potential attack surface.

In some embodiments, encrypted secret 460 may be stored directly in secured storage location 490. Alternatively, as shown in FIG. 4, encrypted secret 460 may further be obfuscated using an obfuscation function 470 to generate an obfuscated secret 480. As used herein, obfuscation may refer to any process designed to conceal or scramble data to make it more difficult to interpret. In some embodiments, obfuscation function 470 may include an encoding technique, such as a base64 encoding. Accordingly, encrypted secret 460 may be mapped to a sequence of text-based characters. As another example, obfuscation function 470 may include appending additional information to encrypted secret 460. For example, adding a version identifier of obfuscation function 470 may ensure that the same de-obfuscation method is consistently applied during decryption. Various other obfuscation methods may be used or combinations thereof. For example, obfuscation function 470 may include various forms of encryption, masking, shuffling, substitution, nulling, anonymization, randomization, tokenizing, blurring, scrambling, or an other techniques that may help hide encrypted secret 460.

As shown in FIG. 4, obfuscated secret 480 (or encrypted secret 460) may be stored in secured storage location 490. Secured storage location 490 may include any storage location within memory 220. In some embodiments, secured storage location 490 may be selected to further increase security of the system. As one example, secured storage location 490 may be a file within memory 220 that is restricted to identity 112. For example, secured storage location 490 may be a file accessible based on identity 112 having been authenticated using security agent 320. In some embodiments, further security measures may be employed to make obfuscated secret 480 more difficult to access. For example, obfuscated secret 480 may be stored in a file having a filename that is known only to security agent 320, such as a unique identifier associated with identity 112. Accordingly, obfuscated secret 480 may appear as a random file that may not seem to include any form of protected data.

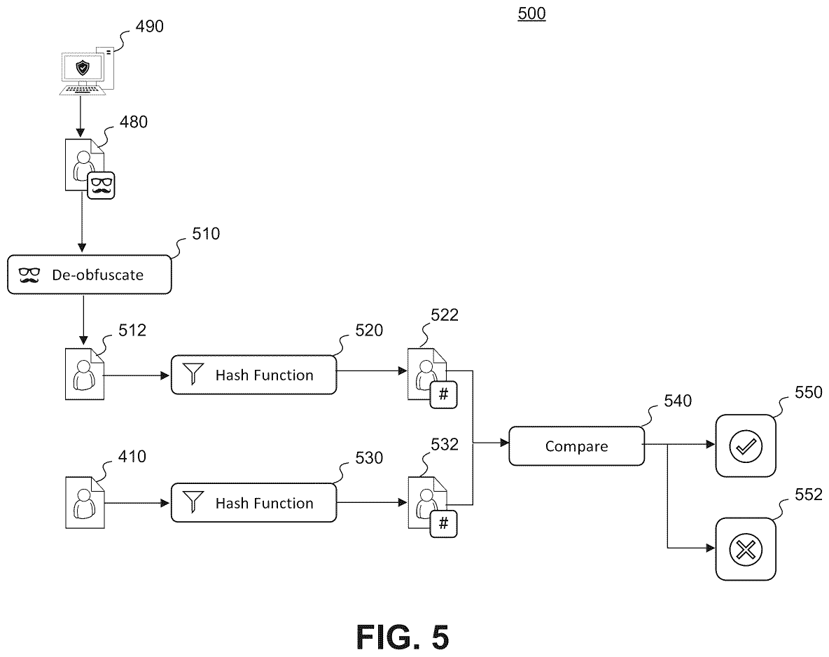

Using the various security layers described herein, or various combinations or sub-combinations thereof, secret 410 may be stored in a highly secure manner. Consistent with the disclosed embodiments, an integrity check of obfuscated secret 480 may be performed to ensure no security breach has occurred. FIG. 5 is a block diagram illustrating an example process 500 for performing an integrity check of a stored secret, consistent with the disclosed embodiments. As shown in FIG. 5, a hash of plaintext secret 410 may be generated, which may be used as a trusted reference for data integrity checks. This may include applying a hashing function 530 to secret 410 to generate hashed secret 532, as shown. Hashing function 530 may include any suitable hashing algorithm, such as a SHA-256 algorithm, as described above. In some embodiments, hashed secret 532 may be generated prior to the obfuscation of secret 410 performed according to process 400. Hashed secret 532 may be stored in a secure location such that it may be referenced later. As one example, hashed secret 532 may be stored in registry 340. Similar to the techniques described above with respect to first encryption key 420, hashed secret 532 may be stored under a user profile in registry 340. In some embodiments, hashed secret 532 may further be stored in an encrypted format. For example, hashed secret 532 may be stored in a JavaScript Object Notation (JSON) format and may be encrypted using a Windows CryptoAPI (or similar encryption tools) and stored in a binary format.

As described above obfuscated secret 480 may be stored in a secured storage location 490. As part of an integrity check, obfuscated secret 480 may be extracted from secured storage location 490 and de-obfuscated using de-obfuscation function 510 to generate a de-obfuscated secret 512. In some embodiments, de-obfuscation function 510 may be an inverse function of obfuscation function 470, described above. Accordingly, de-obfuscated secret 512 may correspond to encrypted secret 460. Process 500 may include inputting de-obfuscated secret 512 into hashing function 522 to generate a hashed de-obfuscated secret 522, as shown in FIG. 5. Hashing function 520 may be the same as hashing function 530. For example, hashing function 520 may include a SHA-256 algorithm, as described above.

Process 500 may further include performing a comparison 540 between hashed de-obfuscated secret 522 and hashed secret 532. If comparison 540 determines hashed de-obfuscated secret 522 is consistent with hashed secret 532, an authentication action 550 may be performed. For example, authentication action 550 may include granting access to operating system 310, granting access to one or more of applications 330, granting access to a restricted resource (e.g., target resource 120), allowing a privileged operation (e.g., editing registry 340, changing an administrator setting, etc.), or any other action that may restricted to authenticated users. Alternatively, if comparison 540 determines hashed de-obfuscated secret 522 is inconsistent with hashed secret 532, a control action 552 may be performed. Control action 552 may include any action responsive to an indication of a potential security breach within computing system 110 and/or network 140. In some embodiments, control action 552 may include rotating a credential. For example, if secret 410 represents a password, control action 552 may include resetting the password. Various other control actions may include causing a message to be presented to identity 112 or another user (e.g., an administrator), causing transmission of an alert indicating the potential breach, triggering an additional authentication of identity 112, locking computing device 110 or one or more of applications 330, or the like.

The disclosed techniques may be used in any application in which it may be desirable to securely store sensitive information. As one possible use case, the disclosed techniques may be used to implement a passwordless authentication technique. The disclosed techniques may be especially applicable to circumvent security requirements that would otherwise prevent a passwordless authentication scheme. For example, identity 112 may initially authenticate to security agent 320 using various forms of authentication, such as multi-factor authentication, biometric authentication, or the like. For future logins, identity 112 may not be required to re-enter the password. However, operating system 310 (or other aspects of computing device 110) may require a password. Accordingly, as part of the initial authentication process, security agent 320 may generate secret 410 in the form of a password, which it may assert to operating system 310 each time identity 112 logs in. However, storing the generated password locally may prevent security vulnerabilities, thus reducing the security benefits of passwordless authentication. However, by implementing process 400 described above, the password may be stored and retrieved in a secure manner such that it may be asserted in the background on behalf of identity 112. Further, using process 500, the integrity of the stored password may be monitored. Identity 112 may thus be required to reauthenticate only when the integrity of the password cannot be verified.

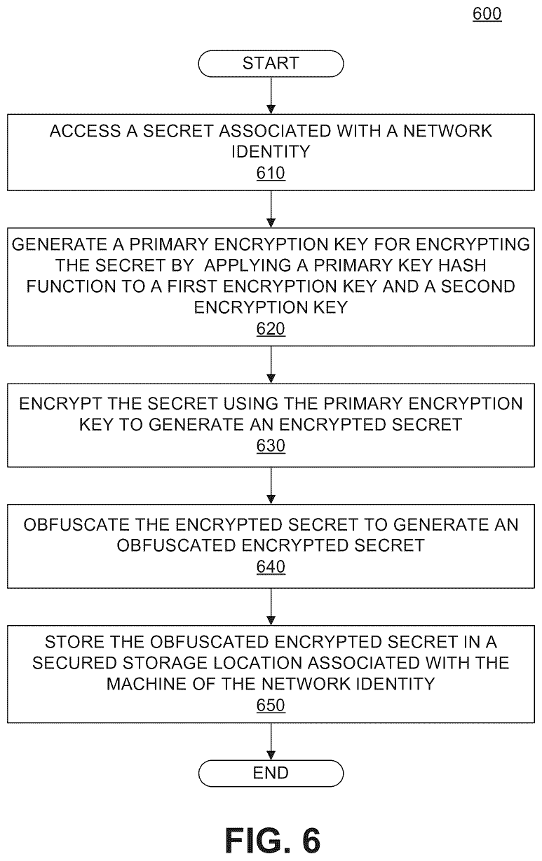

FIG. 6 is a flowchart showing an example process 600 for securely storing a secret, consistent with the disclosed embodiments. Process 600 may be performed by at least one processor of a computing device, such as processor 210 described above. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform process 600. Further, process 600 is not necessarily limited to the steps shown in FIG. 6, and any steps or processes of the various embodiments described throughout the present disclosure may also be included in process 600, including those described above with respect to, for example, FIGS. 3, 4, and 5.

In step 610, process 600 may include accessing a secret associated with at least one network identity. For example, step 610 may include accessing secret 410, which may be associated with identity 112. As described above, the secret can include any form of sensitive data, such as a password, an access-token, a PIN, a username, biometric data, or various other data.

In step 620, process 600 may include generating a primary encryption key for encrypting the secret. For example, step 620 may include generating primary encryption key 440, as described above. Accordingly, step 620 may include accessing multiple keys stored in a distributed manner and generating the primary encryption key based on the accessed keys. Consistent with the disclosed embodiments, step 620 may include accessing a first encryption key associated with the at least one first identity. For example, the first encryption key may correspond to first encryption key 420. In some embodiments, the first encryption key associated with the at least one network identity is unique to the secret. For example, the first encryption key may be generated in association with the secret and may be dedicated to the secret. In some embodiments, the first encryption key may be stored encrypted in a registry associated with the machine of the at least one network identity. For example, the first encryption key may be encrypted using an encryption tool and may be stored in registry 340.

Step 620 may further include accessing a second encryption key stored in a process memory location associated with a machine of the at least one network identity. For example, step 620 may include accessing second encryption key 422, as described above. The second encryption key may be stored such that it is unaffected by a process dump associated with the machine of the at least one network identity. For example, the second encryption key may be hard-coded into a coding of a software agent (e.g., security agent 320) and may be loaded into the process memory with the coding of the software agent. In some embodiments, the second encryption key may be stored in a predetermined format. For example, the predetermined format may include a hexadecimal array, which may make extracting the second encryption key difficult or impossible for an attacker.

Step 620 may further include applying a primary key hash function to the first encryption key and the second encryption key to generate the primary encryption key. For example, this may include applying cryptographic hash function 430 to first encryption key 420 and second encryption key 422 to generate primary encryption key 440, as described above. In some embodiments, the primary key hash function may be configured to generate the primary encryption key to have a predetermined bit length. For example, the cryptographic hash function 430 may be a SHA-256 algorithm and thus the primary encryption key may be a 32-bit key.

In step 630, process 600 may include encrypting the secret using the primary encryption key to generate an encrypted secret. For example, step 630 may include encrypting secret 410 using primary encryption key 440 to generate encrypted secret 460, as described above. In some embodiments, encrypting the secret using the primary encryption key may further include applying a salt to the secret. For example, this may include salting secret 410 using cryptographic salt 442. As described above, the salt may be associated with the machine of the at least one network identity (e.g., computing device 110). For example, the salt may include an identifier of the computing device.

In step 640, process 600 may include obfuscating the encrypted secret to generate an obfuscated encrypted secret. For example, step 640 may include generating obfuscated secret 480 using obfuscation function 470, as described above. In some embodiments, obfuscating the encrypted secret may include an encoding technique, such as a base64 encoding. As another example, obfuscating the encrypted secret may include adding information identifying the obfuscation function.

In step 650, process 600 may include storing the obfuscated encrypted secret in a secured storage location associated with the machine of the at least one network identity. For example, this may include storing obfuscated secret 480 in secured storage location 490, as described above. Consistent with the disclosed embodiments, access to the secured storage location may be restricted to the at least one network identity. For example, in a Windows™ operating system, the secured storage location may be a system32 resource that may be inherently secured and may allow access only to the system users. In some embodiments, storing the obfuscated secret may include generating an obscured filename for the encrypted secret. The obscured filename may be associated with the at least one network identity. For example, the filename may be based on or may a unique identifier of identity 112.

Process 600 may further include various steps for performing an integrity check associated with the stored secret, as described above. In some embodiments, process 600 may include generating a reference hash of the secret. For example, process 600 may include generating hashed secret 532, as described above. In some embodiments, the reference hash of the secret may be stored in a registry in an encrypted format. For example, the reference hash may be stored in registry 340. In some embodiments an integrity check may be performed based on a requested action. For example, process 600 may include receiving a request to access at least one secured resource by the at least one network identity and authenticating the at least one network identity based on the reference hash of the secret. As described above with respect to FIG. 5, authenticating the at least one identity based on the reference hash of the encrypted secret may include: accessing the obfuscated encrypted secret from the secured storage location; de-obfuscating the obfuscated encrypted secret; generating a computed hash of the de-obfuscated secret; and comparing the computed hash of the de-obfuscated secret to the reference hash of the secret.

Process 600 may include performing various actions based on the comparison. For example, process 600 may include determining, based on the comparison, that the at least one network identity is not authenticated; and performing, based on the determination that the at least one network identity is not authenticated, at least one control action (i.e., control action 552). For example, the at least one control action may include resetting the secret. Alternatively or additionally, process 600 may include determining, based on the comparison, that the at least one network identity is authenticated; and allowing access to the at least one secured resource by the at least one network identity using the secret. For example, this may include performing authentication action 550, as described above.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for securely storing a secret, the operations comprising:
accessing a secret associated with at least one network identity;
generating a primary encryption key for encrypting the secret, wherein generating the primary encryption key includes:
accessing a first encryption key associated with the at least one network identity,
accessing a second encryption key stored in a process memory location associated with a machine of the at least one network identity, and
applying a primary key hash function to the first encryption key and the second encryption key to generate the primary encryption key;
encrypting the secret using the primary encryption key to generate an encrypted secret;
obfuscating the encrypted secret to generate an obfuscated encrypted secret; and
storing the obfuscated encrypted secret in a secured storage location associated with the machine of the at least one network identity.

2. The non-transitory computer readable medium of claim 1, wherein the first encryption key associated with the at least one network identity is unique to the secret.

3. The non-transitory computer readable medium of claim 1, wherein the first encryption key is stored encrypted in a registry associated with the machine of the at least one network identity.

4. The non-transitory computer readable medium of claim 1, wherein the second encryption key is stored such that it is unaffected by a process dump associated with the machine of the at least one network identity.

5. The non-transitory computer readable medium of claim 4, wherein the second encryption key is hard-coded into a coding of a software agent and wherein the second encryption key is loaded into the process memory with the coding of the software agent.

6. The non-transitory computer readable medium of claim 1, wherein the second encryption key is stored in a predetermined format.

7. The non-transitory computer readable medium of claim 6, wherein the predetermined format includes a hexadecimal array.

8. The non-transitory computer readable medium of claim 1, wherein the secret includes at least one of a password, an access-token, a PIN, a username, or biometric data.

9. The non-transitory computer readable medium of claim 1, wherein the primary key hash function is configured to generate the primary encryption key to have a predetermined bit length.

10. The non-transitory computer readable medium of claim 1, wherein encrypting the secret using the primary encryption key further includes applying a salt to the secret.

11. The non-transitory computer readable medium of claim 10, wherein the salt is associated with the machine of the at least one network identity.

12. The non-transitory computer readable medium of claim 11, wherein the salt includes an identifier of the computing device.

13. The non-transitory computer readable medium of claim 1, wherein access to the secured storage location is restricted to the at least one network identity.

14. The non-transitory computer readable medium of claim 1, wherein storing the obfuscated encrypted secret includes generating an obscured filename for the encrypted secret, the obscured filename being associated with the at least one network identity.

15. A computer-implemented method for securely storing a secret, the method comprising:
accessing a secret associated with at least one network identity;
generating a primary encryption key for encrypting the secret, wherein generating the encryption key includes:
accessing a first encryption key associated with the at least one network identity,
accessing a second encryption key stored in a process memory location associated with a machine of the at least one network identity, and
applying a primary key hash function to the first encryption key and the second encryption key to generate the primary encryption key;
encrypting the secret using the primary encryption key to generate an encrypted secret;
obfuscating the encrypted secret to generate an obfuscated encrypted secret; and
storing the obfuscated encrypted secret in a secured storage location associated with the machine of the at least one network identity.

16. The method of claim 15, further comprising generating a reference hash of the secret.

17. The method of claim 16, further comprising storing the reference hash of the secret in a registry in an encrypted format.

18. The method of claim 16, further comprising receiving a request to access at least one secured resource by the at least one network identity and authenticating the at least one network identity based on the reference hash of the secret.

19. The method of claim 18, wherein authenticating the at least one identity based on the reference hash of the encrypted secret includes:
accessing the obfuscated encrypted secret from the secured storage location;
de-obfuscating the obfuscated encrypted secret;
generating a computed hash of the de-obfuscated secret; and
comparing the computed hash of the de-obfuscated secret to the reference hash of the secret.

20. The method of claim 19, further comprising:
determining, based on the comparison, that the at least one network identity is not authenticated; and
performing, based on the determination that the at least one network identity is not authenticated, at least one control action.

21. The method of claim 20, wherein the at least one control action includes resetting the secret.

22. The method of claim 19, further comprising:
determining, based on the comparison, that the at least one network identity is authenticated; and
allowing access to the at least one secured resource by the at least one network identity using the secret.
